(19) United States
(12) Patent Application Publication
(10) Pub. No.: US 2002/0178264 A1
(43) Pub. Date: Nov. 28, 2002

(54) Secure creation and distribution of instructions to uniquely support network applications

(75) Inventors: Tomas Benda, Toronto (CA); Gunnar J. Helgason, Colborne (CA); Thomas Wong, Toronto (CA)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: iSource Concepts Inc.

(21) Appl. No.: 09/817,166

(22) Filed: Mar. 27, 2001

(51) Int. Cl. G06F 15/16

(52) U.S. Cl. 709/227

(57) ABSTRACT

A system, method and computer program product for the secure creation and distribution of instructions to support network applications is provided. The system allows nodes within a network to transform from the functionality of a “client” into a “server” with no residual legacy information being discernable by the new function and vice-versa. The method and product function as a browser, built directly onto the network's transport-network layer protocol (e.g., TCP/IP) that does not require pre-defined formats for the presentation of any page, segment, unit, or quantity of information, and without regard as to the information type or category. Therefore, the present invention serves as a network operating platform (or engine) for service providers to offer network-based (e.g., Internet-based) application programs to their clients.

### BACKGROUND OF THE INVENTION

1. Field of the Invention

The present invention relates generally to computer systems, and more particularly to computer operating platforms that support and facilitate distributed network-based application programs.

2. Related Art

In today's technological climate, the availability of low-cost yet powerful computers, networking equipment, telecommunications, and related technology has dramatically changed the way people communicate. That is, as computers have become more powerful and ubiquitous, it has become important to connect them together in networks to facilitate communication among them (and, more importantly, their users). For example, the explosion of people connected to the global (sometimes referred to as the “public”) Internet has dramatically increased the usage of electronic mail (e-mail) for communications, and the use of the browsers to navigate between and view (i.e., browse) documents through the World-Wide Web.

Generically speaking, a network is comprised of “nodes” and “links.” Each node is simply a computation device (e.g., whether personal computer, gateway, router and the like) connected to the network via a communications link. The links, which allow data to be communicated among the several nodes of a computer network, are such that there exists a path from each node over the links and possibly through the other nodes to each of the other nodes in the network. That is, each node may be connected to the network with one or more links. Networks are typically classified according to their geographic extent (e.g., wide-area network or local-area network) and the protocol (i.e., set of formal rules describing how to transmit data across the network) used to communicate among the nodes.

The connectivity achieved by the Internet—connecting a great number of computers within different types of networks—is based upon a common protocol suite utilized by those computers connecting to it. Part of the common protocol suite is the Internet Protocol (IP), defined in Internet Standard (STD) 5, Request for Comments (RFC) 791 (Internet Architecture Board). IP is a network layer (in terms of the International Organization for Standardization (ISO) Open Systems Interconnect (OSI) seven-layer model), packet (i.e., a unit of transmitted data) switching protocol. IP uses address to distinguish among the computers in a network or more specifically, to distinguish among the millions of computers connected to the global Internet. An IP address is specified by a 32-bit host address usually represented in dotted decimal notation (e.g. 128.121.3.5). The IP address format is currently defined in STD 5, RFC 791.

Another major part of the common protocol suite is the Transmission Control Protocol (TCP), which is defined in STD 7, RFC 793. TCP is a transport layer (in terms of the ISO OSI seven-layer model), flow control protocol. As is well-known in the relevant arts, TCP is used over IP (TCP/IP), and together they ensure proper Internet communications. More specifically, IP separates data into packets (i.e., IP datagrams), addresses the IP datagrams, and forwards them from a source computer (node) to a destination computer (node) over one or more communication links. Used in conjunction with IP, TCP holds open a path between the source and destination computers, acknowledges receipt of packets, re-sends lost packets, and guaranties correct packet order.

Most typically, application programs running on computer networks are implemented and described in terms of the “client-server” paradigm. That is, nodes within a computer network are classified as either a “client” or a “server.” The client-server paradigm and the use of the TCP/IP protocol suite is described in detail in Douglas E. Comer & David L. Stevens, “Internetworking with TCP/IP: Vol. III Client—Server Programming and Applications,” ISBN 0-13-474230-3, Prentice Hall (USA 1994), which is incorporated herein by reference in its entirety.

A “client” is a node running a process that requests a service of another process (a “server”) using a protocol (or set of formal rules), and accepts the server's responses. For example, a computer workstation requesting the contents of a file from another computer running a file server process is a client of the file server.

A “server” is a node running a process that provides some process or information to other computers (or nodes) connected to it via a network. The most common example is a computer file server that has a local storage disk, and services requests from remote client computers to read and write files on that disk.

The use of the browsers to navigate between and view (i.e., browse) documents through the World-Wide Web and navigate from one node to another within the Internet is a typical implementation of a “client-server” application program. Thus, within the Internet environment, a programmer may employ TCP/IP to pass data between two or more nodes (i.e., peer-to-peer communications) where nodes are either classified as clients or servers.

Commercially speaking, it is most typical to have an application service provider (ASP) that provides and allows access, perhaps on a subscriber basis or per-use basis, to an application program via the Internet. That is, the ASP would provide the hardware (e.g., server machines) and software (e.g., application software and data stores) infrastructure to allow its customers (e.g., users using commercially available Web browser software) to execute their offered application software. Such application programs typically include Web site offerings such as electronic auction, Internet search engines, entertainment or recreational games, business-to-business tools, chat services, e-mail services, personal financial services, information or news services, data retrieval services, product offerings or the like. Further, the type of application program offered by the ASP dictates the security concerns of data passing between nodes within the network. This is the conventional model.

In a computer network setting, the role of either the client or the server does not change from its defined role of the former at the outset of the computational process, to a new role as the latter, while the computational process is still underway. Similarly, the role of a computational process does not change from the function of a server to that of a client, while the computational process is underway.

At the present time, all Internet browser applications suffer from diminished efficiencies, because the present embodiments of software necessarily treat each computational node on a network as either a “client” only, or a “server.” This rigid “client-server” model does not lend itself well to various tasks, especially in computations using time-sensitive dynamic variables. These dynamic variables may be required to assess situations that are of short duration, or transitive in nature.

Fixed-function processes such as servers, or clients, can not have their function immediately altered, based upon the contents of data just passed to it. This impedes the efficiency of applying logic to those data. In many cases, the presence of specific data must be passed to other locations for computation, due only to the fact that their present location within a process does not permit the appropriate computational operation to execute.

As a direct result of these present inefficiencies, both bandwidth resources and timely information are either compromised or unavailable. Further, within the client-server paradigm, and more specifically within Web browser applications utilizing TCP/IP within the Internet, ASPs are limited in their ability to provide maximum computational power. That is, there is a need for a process engine that removes the structure of a client and a server in the network computational model . With such an engine (or Internet operating platform) in place, application program instructions may be passed from one point to another in an optimized format, and can be executed in a location that may be more efficient for a given process.

Therefore, what is needed is a system, method and computer program product for the secure creation and distribution of instructions to support (Internet) applications that can be executed anywhere in a network. The system, method and product should also comprise a presentation means (e.g., browser) that does not require pre-defined formats for the presentation of any page, segment, unit, or quantity of information, without regard as to its type or category. The system, method, and product should also allow for the presentation of data that can be unique to each of a multiplicity of users, based upon each user's needs at that instant.

### SUMMARY OF THE INVENTION

The present invention meets the above-mentioned needs by providing a system, method and computer program product for the secure creation and distribution of instructions to support network (e.g., Internet) applications. The creation and presentation of these instructions or data can be unique to any node to which it is presented. The system, method and computer program product of the present invention functions as a process engine (e.g., a network operating platform) that removes the structure of a client and a server in the typical network computational model.

The system of the present invention includes a dispatcher machine connected over a network (e.g., the Internet) to several user machines, wherein the dispatcher has means for receiving a connection request from the one of the user machine. The system also includes one or more databases connected to the dispatcher and a cluster of servant nodes. These databases include computational resource data, security information, subscriber information, system status information and application program specific data. The dispatcher, databases and servant machines make up an “engine” or platform that facilitates an ASP's delivery of network-based application programs to its subscribers (i.e., users or customers).

The system further includes means for the dispatcher to access the database in order to select one of the servant nodes that is available (in terms of computational resources) to service connection requests from the user machines, means for sending a code package (i.e., a string of data and executable instruction code) to the user machines, wherein the code package facilitates the user machine's connection to one of the available servant nodes. Further, the system also includes means for the servant nodes to access the databases in order to send a second code package to any of the user machines, wherein the second code package includes instructions and data responsive to queries received from the user machines.

The method and product of the present invention include the dispatcher machine receiving a connection request from one of the user machines and then selecting one of the servant nodes to service the user connection. Then, the dispatcher sends a first code package to the user machine, wherein the first code package includes data that facilitates the user machine connecting to the selected servant node with enough computational resources to service the user connection. The user machine then establishes a connection to the selected servant node by using the data (i.e., logical or physical address of the selected servant node) included in the first code package.

The method and product then commences an application program on the selected servant node. The servant node, in providing the application program to the user, will receive a query from the user, wherein the query is related to the application program. The servant node will then send a second code package to the user machine, wherein the second code package includes instructions and data which may be completely or partially responsive to the query. If partially responsive to the query, the servant machine instructions direct the user machine to execute the instructions (i.e., executable code) and data received from servant node and to then forward a computed answer back to the servant node. The servant machine then parses the answer received from the user machine and combines it with additional data to form a final response to the query received from the user machine. If completely responsive, the servant machine computes the final response. Thus, a final response is formed and then sent to the user machine, whereby the first and second code packages facilitate an ASP's delivery of a network-based application program to a user.

One advantage of the present invention is that it allows computational operations to be performed more efficiently, through reduced network transit latency, by requiring less information to transit the network. The present invention also further decreases network latencies by calculating the expected datagram sizes, and executing such optimizing techniques as “expedited forwarding”, dynamically adjusting maximum transmission unit (MTU) window sizes, or other means which are known to those skilled in the relevant art(s).

Another advantage of the present invention is that it enables each computational node (i.e., addressable computer device) connected to a network to receive computer-determined instructions that are unique to each computational node.

Another advantage of the present invention is that it allows nodes within a network to transform from the functionality of a “client” into a “server” with no residual legacy information being discernable by the new function and vice-versa.

Yet another advantage of the present invention is that it enables scalability that has dramatically fewer restrictions over conventional network-based application provision techniques where client and server functions (roles) are fixed.

Further features and advantages of the invention as well as the structure and operation of various embodiments of the present invention are described in detail below with reference to the accompanying drawings.

### BRIEF DESCRIPTION OF THE FIGS.

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

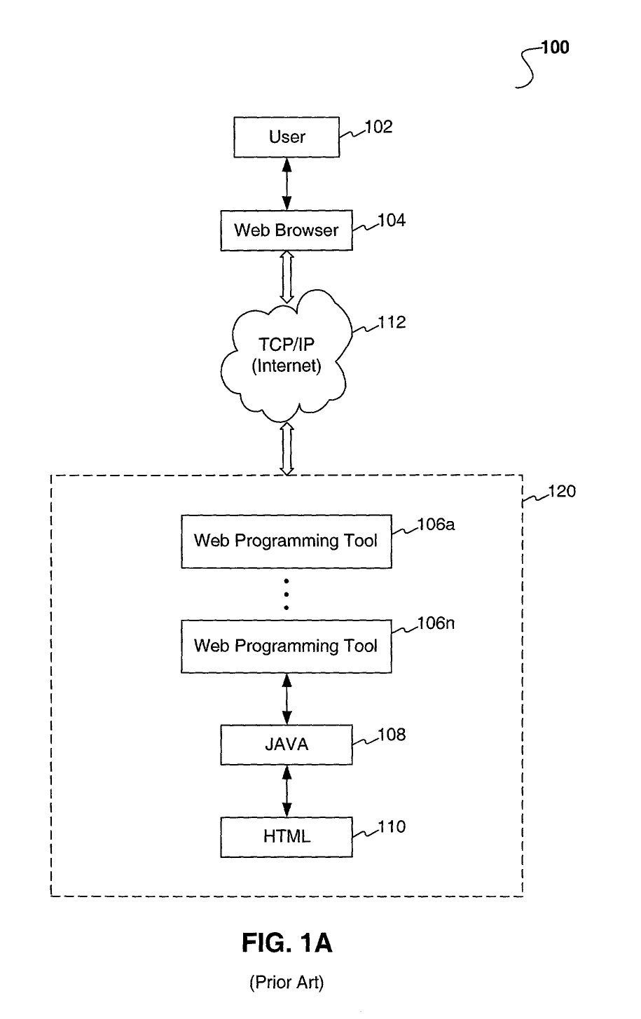

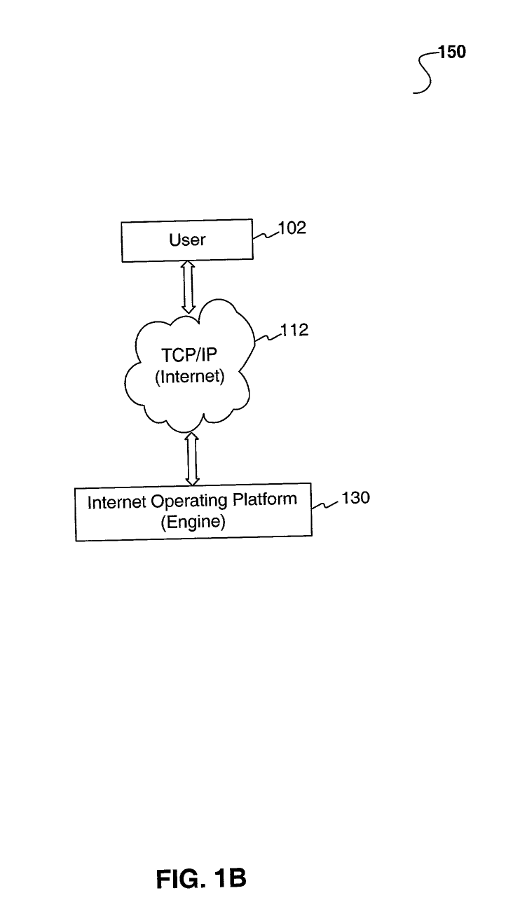

FIG. 1A is a block diagram illustrating a conventional system architecture utilized by an application service provider to offer Web-based application programs to users;

FIG. 1B is a block diagram illustrating a system architecture utilized by an application service provider to offer application programs to users according to an embodiment of the present invention, showing connectivity among the various components;

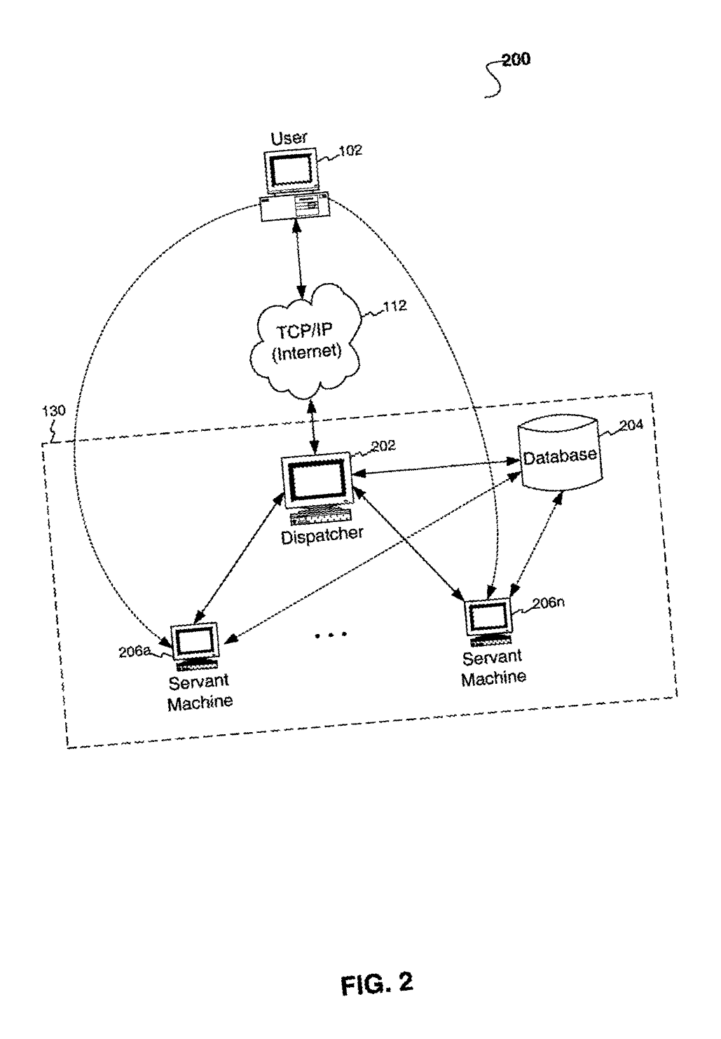

FIG. 2 is a block diagram illustrating the physical architecture of a network operating platform system, according to an embodiment of the present invention, showing connectivity among the various components;

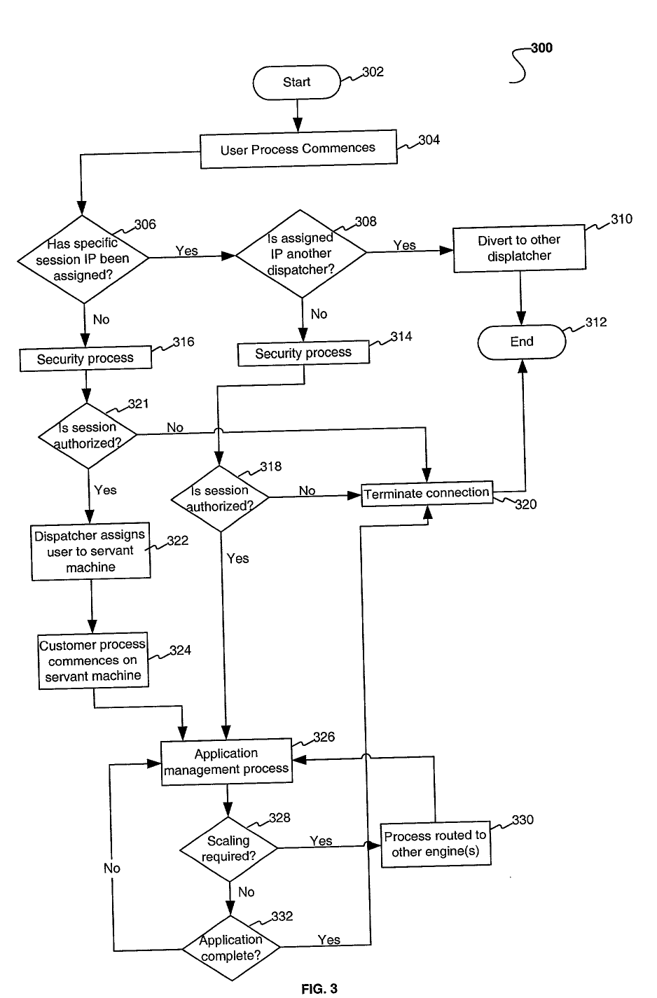

FIG. 3 is a flow chart depicting an embodiment of the operation and control flow of a user utilizing an application program implemented using the process engine (i.e., network operating platform) of the present invention;

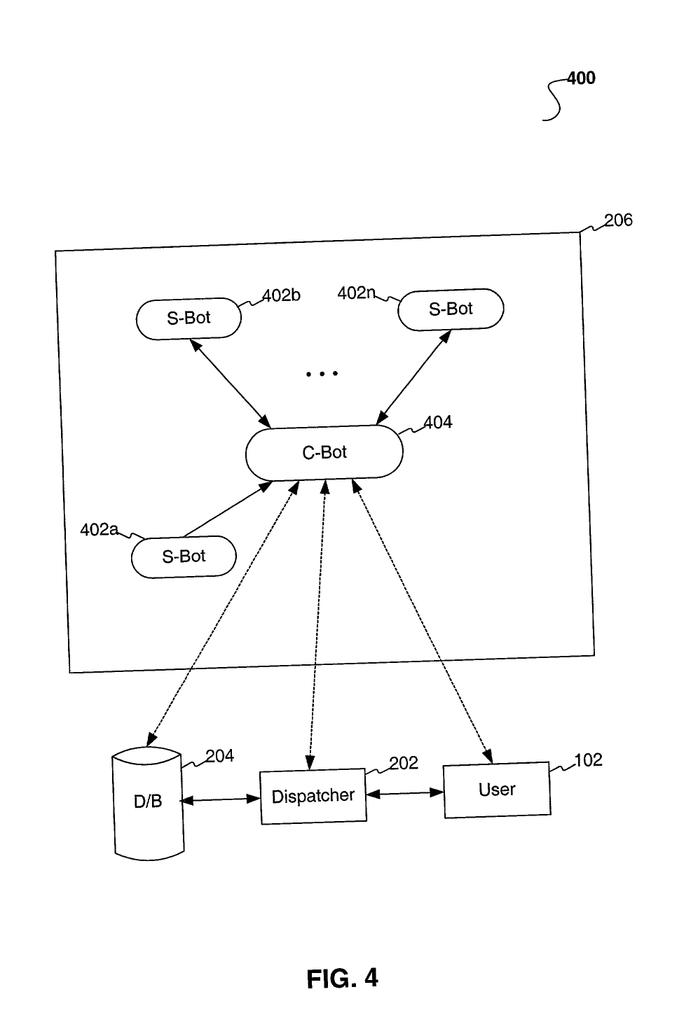

FIG. 4 is a block diagram of the software architecture of part of the process engine (i.e., network operating platform) that resides on the servant machines, according to an embodiment of the present invention, showing connectivity among the various components;

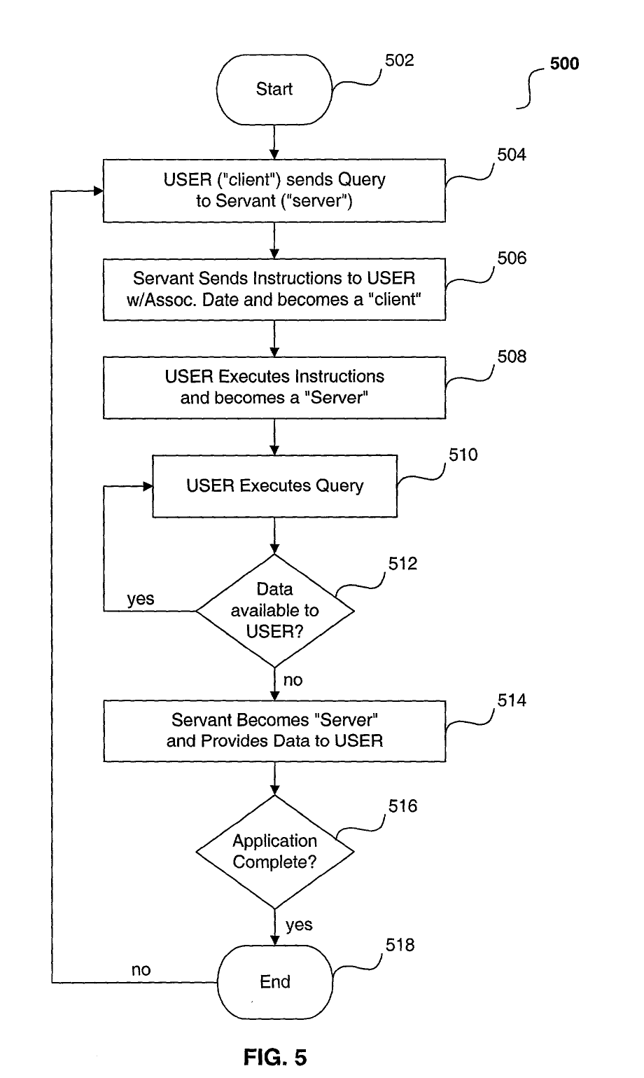

FIG. 5 is a flow chart depicting an embodiment of the operation and control flow of instruction (executable code) and data pushing and client-server switching during the execution of an application program implemented using the process engine (i.e., network operating platform) of the present invention; and

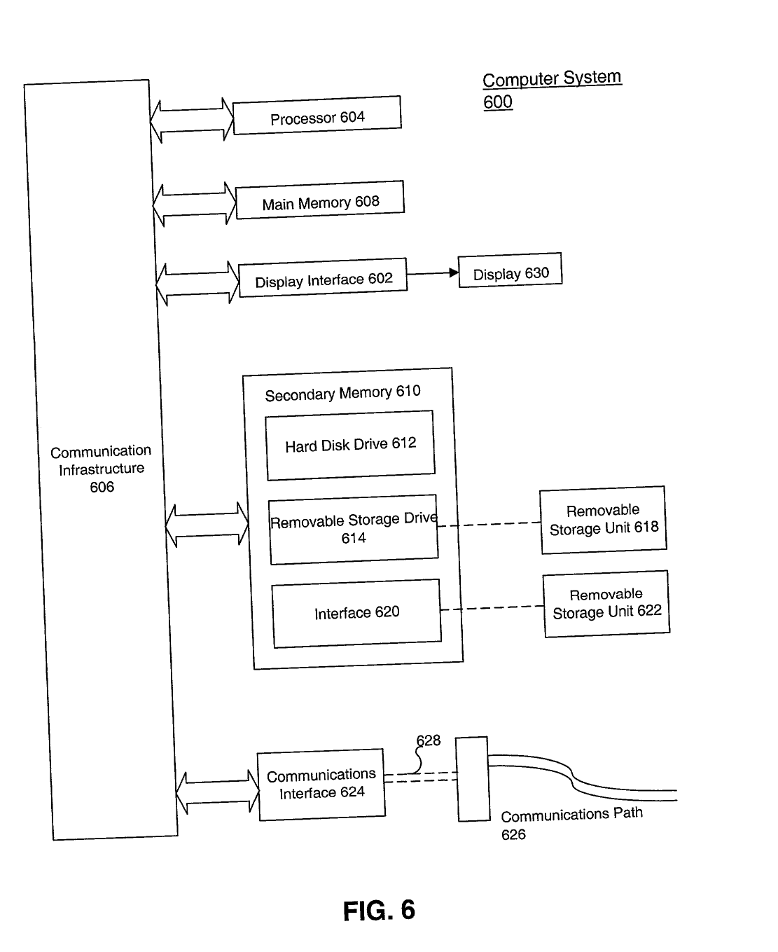

FIG. 6 is a block diagram of an exemplary computer system useful for implementing the present invention.

### DETAILED DESCRIPTION OF THE PREFERRED EMBODIMENTS

| | |
|---|---|
| I. | Invention Overview |
| II. | System Architecture |
| III. | System Operation |
| IV. | Selection of Servant Machines and other Engines |
| V. | Software Architecture |
| VI. | Distributing Instructions and Data (Client-Server Switching) |
| VII. | User Machine Kernel |
| VIII. | System Security |
| IX. | Example Implementations |
| X. | Conclusion |

I. Invention Overview

The present invention relates to a system, method and computer program product for the secure creation and distribution of instructions to support network (e.g., Internet) application programs. The system, method and computer program product of the present invention is, in essence, a process engine (i.e., a network operating platform) that removes the structure of a client and a server in the network computational model.

Referring to FIG. 1A, a conventional system architecture 100 utilized by an application service provider (ASP) to offer Web-based application programs to users via the Internet is shown. That is, architecture 100 reflects the conventional system implementation for an ASP to deliver an application program to a user via a Web site.

First, a user 102 accesses the World Wide Web portion of the (TCP/IP) Internet 112 using a commercially available browser 104 (e.g., Microsoft® Internet Explorer, Netscape® Navigator or Communicator, NCSA Mosaic™ and the like), which is well-known in the relevant art(s). Second, the ASP would provide the application program on (and through) their Web site by using several layers (or a suite) of technologies 120. Suite 120 typically may include a plurality of Web programming tools 106 (shown as Web programming tools 106a-n in FIG. 1). Web programming tools 106 may include tools such as the Macromedia® Flash Web animation tool by Macromedia, Inc. of San Francisco, Calif., the KavaChart™ graphics software tool available from Visual Engineering, Inc. of Los Altos, Calif., and the like.

As will be appreciated by one skilled in the relevant art(s), the exact type and number of Web programming tools 106 would depend on the specific capabilities, features and requirements of the application program being offered by the ASP.

Suite 120 would also typically include additional code logic implemented and written in the Java programming language as well as contain Hypertext Markup Language (HTML) or Extensible Markup Language (XML) documents. The use of Java, HTML, and XML to provide Web-based application programs is well-known in the relevant art(s) and explained in detail in Peter van der Linden, “Not Just Java,” ISBN 0-13-864638-4, Prentice Hall (USA 1997), which is incorporated herein by reference in its entirety. Further, as will be appreciated by one skilled in the relevant art(s), the individual components of suite 120 combine to form the executable(s) of the application program offered to the ASP's users (i.e., clients) 102.

The conventional system architecture 100 has several shortcomings as alluded to above. From the perspective of the ASP, suite 120 often contains conflicting and redundant code, can be complex to manage, difficult to display consistently to all users, impossible to make unique for each user, involves a great deal of time and expense to assemble, and may not adequately meet the security needs of the application program (e.g., a product ordering application program that involves transmitting user credit card information for payment purposes).

Referring to FIG. 1B (and juxtaposing it to FIG. 1A), a block diagram illustrating a system architecture 150 utilized by an application service provider to offer application programs to users according to an embodiment of the present invention, is shown. Architecture 150 allows as user 102 to access the application program provided by the ASP via a communications network 112 (e.g., the Internet using TCP/IP, Fibre Channel Over IP (FCIP) or the like). Unlike architecture 100, however, the present invention provides a stable, robust and secure network (Internet) operating platform (i.e., engine) 130 built directly on top of a network with individually addressable nodes which forms the complete infrastructure to provide the application program offered to the ASP's users (i.e., clients) 102.

Thus, in an embodiment of the present invention, an ASP is provided with the process engine (i.e., the network operating platform) described herein in order to facilitate its offering of one or more application programs to its clients (i.e., users) via an addressable network such as the Internet. The application program(s) may be an electronic auction, Internet search engine, entertainment or recreational game, business-to-business tool, business to consumer tool, chat service, e-mail service, personal financial service, information or news service, data retrieval service, product offering or the like. Further, such client use of the application program would be on a subscriber basis or a per-use basis, as applicable. That is, the ASP would provide the hardware (e.g., server machines) and the software (e.g., application software code logic and data stores) infrastructure to allow its customers to use the offered application programs(s).

Further, the engine of the present invention provides a means and method to allow a computational entity that performs the functions solely of a “client,” to be immediately, altered to solely perform the functions of a “server,” without regard as to the geographic, physical, or network topological location. It also provides the means and mechanism for a computational entity that performs the functions solely of a “server”, to be immediately and without human intervention, altered to solely perform the functions of a “client”, without regard as to the geographic, physical, or network topological location.

The net result of the engine 130 of the present invention is the effective control of the function of each computing node in the network, on a step-wise basis, for each and all processes. This control is not arbitrated by direct, immediately cognitive, human interaction. Rather, the contents of the data and application instructions which are present on the network, define, manage, and control the processes, based upon the logic stored or calculated within the engine 130.

The present invention is described in terms of the above example. This is for convenience only and is not intended to limit the application of the present invention.

In fact, after reading the following description, it will be apparent to one skilled in the relevant art(s) how to implement the following invention in alternative embodiments (e.g., networks other than the Internet, transport/network protocol suites other than TCP/IP (e.g., UDP/IP), and application programs other than those enumerated herein, and the like).

The terms “user,” “subscriber,” “customer,” “entity,” “company” and the plural form of these terms are used interchangeably throughout herein to refer to those who would access, use, and thus benefit from an application program facilitated by the engine of the present invention.

Lastly, “scalability” is used herein to describe an ability whereby a determination is made by the engine 130 processes that there is a requirement for further resources to be added or activated, to enable the continued efficiency of an operation or process, and such an expansion is possible. As a result of this decision, and its execution, additional processes or resources may be added to the computational resources. This maintains the continued efficiency of the outstanding processes.

II. System Architecture

Referring to FIG. 2, a block diagram illustrating the physical architecture of a network (e.g., Internet) operating platform system 200, according to an embodiment of the present invention, is shown. FIG. 2 also shows connectivity among the various components of system 200. That is, system architecture 200 (architecture 150 shown in FIG. 1B) provides the stable, robust and secure engine 130 (as also shown in FIG. 1B) built directly on top of TCP/IP which forms the complete infrastructure to provide the application program offered to the ASP's users (i.e., clients) 102.

System 200 includes a plurality of users 102 (shown as a single user 102 in FIG. 2 for ease of explanation) which would access system 200 using a personal computer (PC) (e.g., an IBM™ or compatible PC workstation running the Microsoft® Windows™ operating system, Macintosh® computer running the Mac® OS operating system, or the like), and running a commercially available Web browser. In alternative embodiments, users 102 may access system 200 using any processing device including, but not limited to, a desktop computer, laptop, palmtop, workstation, home appliance, automobile, telephone, TV set-top box, personal digital assistant (PDA), and the like.

The users 102 would directly connect to the parts (i.e., infrastructure) of the system 200 which are provided by the ASP (i.e., elements 202-206 of FIG. 2) via the communications network (e.g., the Internet) 112. A dispatcher 202 is provided as the primary means to connect the ASP's infrastructure to the user 102. That is, in one embodiment of the present invention, a dispatcher machine 202 is connected to network 112 and receives connection request from the users 102 of the network 112 to provide the services/functionality of the ASP's application program(s).

The dispatcher 202 is connected to an application database 204, explained in more detail below, which stores data relevant to the physical attributes of system 200, personal attributes of users 102, as well as data relevant to the ASP's offered application program(s). Also included within system 200 are a plurality of servant machines 206 (shown as servant machines 206a-n in FIG. 2). As users 102 connect to the dispatcher 202 requesting the services/functionality of the ASP's application program(s), the dispatcher 202 is responsible for selecting and assigning a servant machine 206 to service each user 102. Consequently, as suggested by FIG. 2, each user 102 machine is also capable of establishing a direct connection to each of the servant machines 206. Further, each servant machine 206 is also connected to the database 204 in order to log statistics concerning their operation (i.e., load, number of users, etc.), thus making that information centrally available to the dispatcher 202.

While one database 204 is shown in FIG. 2 for ease of explanation, it will be apparent to one skilled in the relevant art(s) that the system 200 may utilize a plurality of databases physically located on one or more computers which may or may not be the same machine as dispatcher 202, and/or functionally divided to efficiently achieve the functionality of the specific application program(s) offered by the ASP, as applicable.

In fact, in a preferred embodiment of the present invention, system 200 would include, by way of example, at least six separate databases 204 (referred to herein individually as database 204a-f, respectively, and database(s) 204 collectively), for each of the following types of possible data:

(204a) computational resources data (i.e., list of available servant machines 206 and their associated loads, etc.);

(204b) security data (e.g., list of “offending” network addresses which have previously tried to obtain unauthorized access to the ASP's application program(s), etc.);

(204c) application program specific data (e.g., sound files, game character data, application data files, etc.);

(204d) documentation data (i.e., form templates and associated data for dynamical creation and filling of forms during application program execution);

(204e) administrative subscriber data (e.g., user 102 login and password data, user 102 profiles, user 102 preferences, etc.); and

(204f) user system data (e.g., hardware profile, network connection type, connected peripheral devices, etc. of each user 102).

The databases 204 are event driven, and actively indicate the status of information in real-time. Further, one or more of these several databases 204a-f described above may be mirrored (i.e., duplicated and physically separated stores of redundant data) for system 200 operational fault tolerance purposes.

Similarly, in an embodiment of the present invention, a plurality of dispatchers 202, explained in more detail below, is provided by the ASP in a distributed fashion in order to efficiently and quickly service users 102 globally. Each such dispatcher 202 could then perform dispatching functions, as described herein, for a separate plurality (or cluster) of servant machines 206.

In an embodiment of the present invention, the dispatcher 202 and servant machines 206 are IBM® or compatible PC workstations with an Intel® Pentium® III processor running the BSD Unix operating system. In yet another embodiment of the present invention, the dispatcher 202 (and its associated processes) may reside on the same physical machine as one of the servant machines 206.

Components 202, 204 and 206 of the system 200, as will be apparent to one skilled in the relevant art(s), are connected and communicate via a wide or local area network (WAN or LAN).

As used herein, “engine 130” refers to at least one dispatcher 202, a database 204 and a cluster of servant machines 206 that are physically interconnected and together operate to provide the functionality and advantages of the network operating platform described herein. Thus, as will be appreciated by one skilled in the relevant art(s), an ASP may offer its application program(s) to users 102 through one or more (mirrored) engines 130 within system 200.

More detailed descriptions of the system 200 components, as well their functionality and inter-functionality with other system 200 components, are provided below.

III. System Operation

Referring to FIG. 3, a flow chart of a sample control flow 300, according to an embodiment of the present invention, is shown. More specifically, control flow 300 depicts a user 102 connecting to and using an application program offered by an ASP and implemented on system 200 described above with reference to FIG. 1. Control flow 300, which highlights the functionality, scalability, and other advantages of system 200, begins at step 302, with control passing immediately to step 304.

In step 304, the user 102 establishes a network 112 connection (e.g., using TCP/IP) to the dispatcher 202 in order to utilize an application program offered by the ASP. In a preferred embodiment of the present invention, an ASP would be able to provide users 102 with an icon on the graphical user interface of the operating system they are utilizing (e.g., Microsoft® Windows™) in order to establish this connection. The icon would, when clicked, for example, execute software code logic on the user machine to establish a connection to the network address (e.g., IP address) of the dispatcher 202 in a well-known manner.

In step 306, the dispatcher 202 determines whether the user 102 has been previously assigned a session and a servant 206 process location. That is, dispatcher 202 determines if the user 102 was re-connecting to the system 200 after being prematurely (i.e., accidentally) disconnected or terminated. If so, in step 308, control flow 300 determines if the user has reconnected to the same dispatcher 202 as before. If not, in step 310, the user is redirected to the same dispatcher 202 it previously connected to before being prematurely disconnected or terminated. Control flow 300 then ends as indicated by step 312.

Steps 306-312 reflect the fact, as suggested above, that system 200 may include multiple engines 130 (i.e., multiple dispatchers 202 each connected to different databases 204 that are, in turn, connected to a separate cluster of servant machines 206). That is, the ASP may utilize one or more separate engines 130 that operate in a distributed fashion. This allows, for example, a world-wide ASP to physically distribute data among its different resources (i.e., components 202, 204 and 206) for scalability and/or fault tolerance purposes. Further, this allows the ASP to mirror its engines 130 to make its application program(s) quickly available to local users or to reduce the load on heavily utilized engines 130.

Returning to FIG. 3, if the user 102 has reconnected to the same dispatcher 202 as before, control flow 300 proceeds to step 314. In steps 314 and 318, a security process determines whether the user 102 is actually the same user as before and then determines if they are authorized to access the network. This determination, in an embodiment of the present invention, is made by consulting database 204b (security data) to verify the source IP address of the user 102. In yet another embodiment of the present invention, the user 102 may have to provide a login and password, verified by accessing the administrative subscriber data within database 204e, to access the network.

If in step 306, the dispatcher 202 determines the user 102 has not been previously assigned a session, control flow 300 proceeds to step 316. In steps 316 and 321, a security process determines if the user 102 is authorized to access the application program. This determination, in an embodiment of the present invention, is made by the dispatcher 202 consulting database 204b (security data) to verify the source network address of the user 102. In yet another embodiment of the present invention, the user 102 may have to provide a login and password, verified by accessing data within database 204e—administrative subscriber data) to access the application program.

If in steps 318 or 321, the user is determined to be unauthorized to access the application program, control flow 300 proceeds to step 320. In step 320, the connection to the dispatcher 202 established by the user 102 is terminated and control flow 300 then ends as indicated by step 312. In an embodiment of the present invention, the termination event is logged to database 204 (i.e., security data) as an “offending” network address for future use as will be apparent to one skilled in the relevant art(s). In another embodiment of the present invention, the connection established by the user 102 session to the dispatcher 202 is not terminated, but the user is directed to a “demo” mode of the application program where no “real-world” data may be viewed, manipulated, or changed.

If in step 321, the user is determined to be authorized to access the application program, control flow 300 proceeds to step 322. In step 322, the dispatcher 202 determines which specific servant machine 206 is available (i.e., which servant machine has the available computation resources in order to service the user 102 session and provide the application program). This determination is dynamically made based on the criteria reflecting the current state of the system 200 (e.g., number of servant machines 206 present in system 200, load of each servant machine 206, number of connected users 102, etc.). In an embodiment of the present invention, such (real-time) criteria would be available to the dispatcher 202 by accessing database 204a (computational resources data) as explained in more detail below.

Once the availability determination is made, the dispatcher 202 assigns that specific servant machine 206 to the user 102 by supplying the user 102 with the network address of the servant machine 206 and instructions indicating how to establish a direct connection with the servant machine 206. The provision of connection instructions and data (i.e., IP address) to the user 102 is described in more detail below. At this point, the connection between the dispatcher 202 and user 102 is terminated. Then, in step 324, the user 102, utilizing the network address data and instructions received from the dispatcher 202, establishes a connection to the assigned servant machine 206. Control flow 300 then proceeds to step 326.

If in step 318, the user is determined to be authorized to access the network, the dispatcher 202 supplies the user 102 with the Network address of the servant machine 206 and instructions indicating how to establish a connection to the servant machine 206 as described in more detail above. Control flow 300 can then proceed to step 326.

In step 326, the application management process supplied by the engine 130 of the present invention commences. The application management process of step 326 is a dynamic process which provides the ASP's application program and specific resources to the user 102. That is, step 326 (and steps 328-332) represents the commencement of the execution of the application program on the servant machine 206 as it interacts (i.e., passes data and instructions back and forth) with the user 102. In an embodiment of the present invention, the user 102 may have to provide a login and password, verified by accessing database 204e (administrative subscriber data), to access the network. In yet another embodiment of the present invention, in step 326, the user may be presented with a choice of multiple application programs offered by the ASP.

During the execution of the application program, in step 326, the servant machine 206 receives queries from the user, parses them, and determines what resources (i.e., what data among database 204) is required to respond to such queries. In this context the system 200 implementing the ASP's application program appears to operate in the conventional client-server paradigm. That is, the user 102 machine behaves as a client machine executing client processes and the servant machine 206 behaves as a server machine executing server processes. However, the provision of the application program to the user 102 and its execution involves the exchange of data and instructions between the user 102 machine and the servant machine 206 that switches their respective roles.

The engine 130 allows a computational entity (i.e., user 102 machine processes) that conventionally performs the functions solely of a “client,” to be immediately and without human intervention, altered to perform the functions of a “server. ” It also allows a computational entity (i.e., servant machine 206 processes) that conventionally performs the functions solely of a “server,” to be immediately and without human intervention, altered to perform the functions of a “client.” This is achieved by the “pushing” back and forth of instructions (and associated data) derived from computed logic and not human interaction with no residual legacy information being discernable by the new function (the new “client” or the new “server”). The pushing of instructions and data is explained in more detail below.

The application management process of step 326 parses queries to determine the probable location of resources required to answer any user 102 query—e.g., if query is “where is shipment from Purchase Order No. 123?”, it would determine that information may be found in a Business Information Resources database 204c (i.e., an application specific database). The query is thus routed to one database—database 204c—rather than all of the databases 204, to improve engine 130 efficiency.

The application management process of step 326 also includes a dynamic routing process that iteratively calculates the average throughput of a user 102 session while connected to the engine 130, and has the ability during the session to place users 102 who are working slowly, onto slower connections (“skinny pipes”), by re-assigning the network connection location. This re-assignment does not require the session to stop. The dynanic routing process also enables a “lost” or “dropped” connection to be resumed, without knowledge or interaction by the user 102. This is accomplished by the engine 130 storing the details of each socket connection, and utilizing a routing table with information concerning the connecting of the two sockets. It simply re-opens the path between the two sockets, and informs the user kernel that the socket connection has been reconnected.

Returning to FIG. 3, in step 328 the servant machine 206 will need to determine whether scaling is required. That is, the servant machine 206 will determine if the data required to respond to the query received from the user 102 is not presently located within the database 204 directly accessible to it.

Step 328 reflects the fact, as suggested above, that system 200 may include multiple engines 130 (i.e., dispatchers 202 each connected to different databases 204 which are connected to separate cluster of servant machines 206). That is, the ASP may utilize one or more separate engines 130 that operate in a distributed fashion within system 200. This allows, for example, a world-wide ASP to physically distribute data among its different resources (i.e., components 202, 204 and 206) for scalability and/or fault tolerance purposes. Further, this allows the ASP to mirror its engines 130 to make its application program(s) quickly available to local users or to reduce the load on heavily utilized engines 130.

If step 328 determines that the data required to respond to the query received from the user 102 is not locally available, the query process of the user 102 is routed to a different engine 130 as explained in greater detail below. If not, the user query is responded to and a determination is made in step 332 whether the application program is complete (i.e., the user is done and has logged off). If so, the connection to the servant machine 206 established by the user 102 is terminated in step 320 and control flow 300 then ends as indicated by step 312.

As will be apparent to one skilled in the relevant art(s), the operation of steps 326-332 would access database 204 (i.e., the various types of possible data described herein) during the provision of the application program to the user 102.

It should be understood that control flow 300, which highlights the functionality, scalability, and other advantages of system 200, is presented for example purposes only. The architecture of the present invention is sufficiently flexible and configurable such that users 102 may navigate through the system 200 in ways other than that shown in FIG. 3.

IV. Selection of Servant Machines and Other Engines

As mentioned above with reference to FIG. 3 (i.e., step 322), the dispatcher 202 determines which specific servant machine 206 is available to service the user 102. This determination is dynamically made based on the criteria reflecting the current state of the system 200 (e.g., number of servant machines 206 present in system 200, load of each servant machine 206, number of connected users 102, etc.). In an embodiment of the present invention, such (real-time) criteria would be available to the dispatcher 202 by accessing database 204a (computational resources data).

In an embodiment of the present invention, dispatcher 202 executes code logic to determine which of the plurality of servant machines 206 is available and most suited for a user 102 wanting to establish a session to the engine 130. The code logic executing on the dispatcher 202 communicates with database 204a (which is a “live” database) that contains information regarding the state of the servant machines 206 and the system 200 in general.

More specifically, the computational resources database 204a contains active information specifics as to which nodes with computational abilities are presently connected to a specific engine 130, exactly where those computational resources exist (according to logical location, as through a network address or other digital location), where all routing gateways may exist, what devices are on what domains, system latency between all devices, etc. The database 204a is also kept aware of the existence of other engines 130, at other network locations, that can perform some or all of the same functions. For example, database 204a contains the name, address, processor power rating, available storage and work space, available task queues, and present load factor for every device connected to system 200. As each event changes the status of facts regarding what devices are connected, or where they are, the database 204ais updated. The database values are stored, after active polling of each resource by the engine 130 code logic, and actively indicates the status of information in real-time.

At any instant in time, the engine 130 can decide from a simple arithmetic calculation, where the best computational power is located. This information is then made available to the dispatcher 202. The dispatcher 202 can then direct a user 102 to a location (i.e., servant machine 206) to begin the provision of the application program (i.e., the process of resolving user queries). When the dispatcher 202 calculates the best location (i.e., available servant machine 206) for a customer to connect to the engine 130, the dispatcher 202 passes that specific location to the kernel (explained in more detail below) on the user machine.

Several mnemonics are presented in TABLE 1 below which illustrate some of the criteria, and calculations based on these criteria that the code logic within the dispatcher 202 may use in making its servant machine 206 availability determination.

TABLE 1

| MNEMONIC | DESCRIPTION |
|---|---|
| AU_{tc}Eₙ | Number of Active Users connected to Engine n |
| Eₙ | Identifies the Engine number, in the array of on-line |
| | engines |
| EₙₐₙEP | calculated as Number of Available Network Entry Points |
| | on Engine n (EₙtₙEP-EₙoₙEP) |
| EₙCₙ | Identifies the Engine computer number (from 1 to n) that |
| | is online in the engine |
| EₙCₙPₙ | Identifies Engine n Computer number (from 1 to n) |
| | and Process number (from 1 to n) that is online in the |
| | engine |
| EₙCₙPₙQₙ | Identifies the Engine number, Computer number, Process |
| | number, and Task Queue number (from 1 to n) that |
| | is online in the engine |
| EₙCₙPₙQₙTLₙ | Identifies the Engine number, Computer number, Process |
| | number, Queue number, and Task List size for a task |
| | queue |
| EₙCRₙCP | Calculated as Engine n, Computing Resource n, raw |
| | Computing Power |
| EₙCRₙPₙ | Engine n, Computing Resource n, number of Processes n |
| EₙOₙEP | Number of Occupied Network Entry Points on Engine n |
| EₙSWV | Defined as the Switch Weighting Value for Engine n |
| EₙTLL | Calculated as the present threshold limit load of Engine n |
| | (when this value exceeds EₙTLV, the engine is no longer |
| | able to accept commence new sessions |
| EₙTLH | Calculated as the Threshold Limit headroom for Engine n |
| EₙTLV | Calculated or stated as the threshold limit value of |
| | Engine n (calculations producing values above this value, |
| | cause Dispatcher to re-direct the user attempting to |
| | connect, to a different engine) |
| EₙₜₙEP | Number of Total Network Entry Points on Engine n |
| L_{c}EₙUₙ | Calculated as Latency, (Communication) between Engine |
| | n and User n (LₜₙEₙUₙ + LₜₐEₙ) (Network + Engine, 1 |
| | way to user) |
| LₜₐEₙ | Calculated as Latency, (Total Assembly and Aggrega- |
| | tion) for Engine n (Compression, Encryption, etc.) (Host |
| | Engine only) |
| L_{tc}UₙEₙ | Calculated as Latency, (Total Communication) between |
| | Engine n and User n (Network + Engine, User to Host) |
| LₜₙEₙEₙ | Calculated as Latency, (Total Network) between |
| | two different Engines |
| LₜₙEₙUₙ | calculated as Latency, (Total Network), between Engine |
| | n and User n (Network, 1-way) |
| L_{trc}EₙUₙ | Calculated as Latency (Total Return Communication) |
| | between Engine n and User n (Network + Engine, return) |
| LₜᵣEₙEₙ | Calculated as Latency, (Total Network), between |
| | Engine n and Engine n (Network, 2-way) |
| LₜᵣEₙUₙ | calculated as Latency, (Total Return) between Engine |
| | n and User n (Network, 2-way) |
| PₜEₙ | Total Number of Processes running on Engine n |
| SU_{tc}Eₙ | Number of Stalled Users connected to Engine n |
| UₙCP | Calculated as the User n Computing Power, it is an index |
| | of how powerful the user computer is. It is derived from |
| | the time required for the User n computer to produce an |
| | answer to a standard mathematical question. |
| UₙTP | Calculated as the data throughput of User n, by taking the |
| | amount of data received from User n, and dividing by a |
| | time unit |
| U_{tc} | Calculated as the total number of users connected to all |
| | PB Engines (Sum of U_{tec}E₁ to U_{tc}Eₙ) |
| U_{tec}Eₙ | Calculated as Total Number of Users connected to |
| | Engine n (AU_{tc}Eₙ + SU_{tc}Eₙ) |

Thus, given the mnemonics of TABLE 1, an exemplary servant machine 206 availability determination may involve any computation involving these mnemonics. For example, the current utilization load of any resource within system 200 may be calculated by arithmetically calculating a resulting variable that is derived from the following factors: length of the queue of commands waiting to be processed by each computational resource, the computational power of each resource, the complexity of each of the queued commands for that resource, and the network latency of each computational resource.

In an embodiment of the present invention, the dispatcher 202, other program variables, or operator declarations will set a threshold load limit value for each engine 130. When a user 102 makes a connection to a dispatcher 202-assigned servant machine 206, the servant machine 206 then informs the computational resources database 204a and the system database 204f that a new user 102 has connected to it, and the new user 102 has a computational resource load factor of x. This factor is a calculation of the variables LₜᵣₙEₙUₙ and UₙCP. When the value of that threshold is exceeded, the dispatcher 202 then directs all new customers to connect to another engine 130 at a specific location. That is, a condition where the number of users and processes connected to one engine 130 exceeds the threshold limit value for that engine (i.e., EₙTLL>EₙTLV), would cause the dispatcher 202 to issue a connection destination directing the user 102 attempting to start a session to a remote dispatcher 202 connected to a remote engine 130 at a different location (see step 310 of FIG. 3).

In an embodiment of the present invention, the location and availability of this “other engine” 130 is known to the “local” dispatcher 202, by communicating with a centrally located database 204a containing computational resources data for all of the ASP's engines 130. That is, the values of EₙBTLV and EₙTLL are stored in all computational resource databases 204a in every engine 130 which is part of system 200.

In an embodiment of the present invention, regarding the determination of the throughput of a user 102 connection—by using such information as LₜᵣₙEₙUₙ, UₙCP, EₙCRₙCP, other information as identified by the mnemonics listed in TABLE 1, and other transitive determinations—the servant machine 206 has the ability to assign priority to both the allocated bandwidth of a user 102, and the efficiency of the connection. This priority may be achieved by the assignment of the user 102 to a particular connection point (i.e., servant machine 206) in the system 200 chosen by the dispatcher 202. Using this method, high-volume, high-engined users (i.e., those with high UₙCP values) can be assigned to any “fat pipe” (i.e., high bandwidth) connections for improved throughput or efficiency of the engine 130. Similarly, users with low UₙCP values or low LₜᵣₙEₙUₙ values, can be moved to slower connections. Alternatively, beyond a certain EₙTLV, the dispatcher 202 may decide to aggregate a large number of slow users into one “fat pipe” connection, and reserve bandwidth for a priority process to specific users 102 (e.g., a request from a business service provider to download or upload a large file or database, such as a catalog or price list).

In an embodiment of the present invention, the scaling process of step 328 of control flow 300 would also utilize the mnemonics of TABLE 1. For example, a first engine 130 may presently have an E₁TLV (i.e., EₙTLV) of 99, with a E₁TLL of 100. Further, one hundred users 102 are connected to the first engine 130 (denoted by the mnemonic “E₁”). Then, for example, one of the hundred users 102 requires an answer to the determination of the net present value of a lease (in dollars) that the user 102 wants to sell. This process, due to its arithmetic complexity, will add 25 to the E₁TLV, which would put it over its E₁TLL. However, a second engine 130 (denoted by the mnemonic “E₂”) has an E₂TLL of 100, and the E₂TLV is only 15. The scaling process of step 328, which is constantly polling these values, is queried by the dynamic routing process and given an alternate location-in this case, the second engine 130 (E₂). The scaling process (in step 330) then directs this single computation step in the process to the second engine 130, and also directs the second engine 130 to send the result back to the first engine 130, for inclusion with the rest of the process. The scaling process also determines communication latencies such as LₙEₙEₙ between the two engines 130 (E₁ and E₂).

It should be understood that the mnemonics reflecting the criteria presented herein, which highlight the functionality and other advantages of system 200, are presented for example purposes only. The software architecture of the present invention is sufficiently flexible and configurable such that the dispatcher 202 may make assignments to servant machines 206 within the system 200 or the servant machines 206 may select other engines 130 using criteria (and thus, mnemonics) other than those presented in TABLE 1.

V. Software Architecture

Referring to FIG. 4, a block diagram of a software architecture 400 of the part of the process engine (i.e., network operating platform) 130 that resides on the servant machines 206, according to an embodiment of the present invention, is shown. FIG. 4 also shows connectivity among the various components of architecture 400. Software architecture 400 reflects that part of the code logic that comprises engine 130 which resides on the servant machines 206. (The other portions of the code logic reside on the dispatcher 202 and database 204.) Thus, FIG. 4 illustrates a servant machine 206 which includes a plurality of S-bot processes 402 (shown as S-bot processes 402a-n) and a central C-bot process 404.

Each S-bot process 402 is capable of servicing a session with a user 102. Thus, as suggested above, each servant machine 206 may service a plurality of users 102 simultaneously. Further, the C-bot process 404 acts a central controller for the S-bot processes 402 and handles communications between the servant machine 206 and the user 102 and databases 204.

In a preferred embodiment, the software code logic implementing each of the S-bot processes is multi-threaded. That is, the program execution environment interleaves instructions from multiple independent execution “threads.” The multi-threaded S-bot processes 402 thus allow multiple instances of each component (thread) to run simultaneously thereby increasing the throughput of the system 200 as a whole. As will be apparent to one skilled in the relevant art(s), each thread comprising an S-bot process 402 is responsible for performing a specific task within the specific application program (e.g., calculating the dot product of a matrix, calculating the value of π to a certain level of precision, etc.). Consequently, each thread within an S-bot process 402 is identified by a network address (i.e., the network address of the servant machine 206 it is executing on), a port number, and a unique socket number.

In a preferred embodiment of the present invention, the code logic that comprises the engine 130, which is distributed among the servant machines 206 (and the dispatcher 202 and database 204), is implemented using a high-level interpretive programming language such as real-time interpretive C++, Java, the “J” programming language available from such vendors as Iverson Software, Inc. of Toronto, OT (Canada), and the “K” programming language available from Kx Systems, Inc. of Miami, Fla. The use of an interpreted programming language (rather than a compiled programming language) is advantageous in performing the pushing of instructions (i.e., executable code) and associated data between the servant machines 206 and the user 102 machines as described in greater detail below.

In an embodiment of the present invention, the dispatcher 202 and C-bot process 404 communicate with database 204 using the Open Database Connectivity (ODBC) interface. As is well known in the relevant art(s), ODBC is a standard for accessing different database systems from a high level programming language application. It enables these applications to submit statements to ODBC using an ODBC structured query language (SQL) and then translates these to the particular SQL commands the underlying database 204 product employs.

In an embodiment of the present invention, one or more of the databases 204 are implemented using a relational database product (e.g., Microsoft® Access, Microsof® SQL Server, IBM® DB2®, ORACLE®, INGRES®, or the like). As is well known in the relevant art(s), relational databases allow the definition of data structures, storage and retrieval operations, and integrity constraints, where data and relations between them are organized in tables. Further, tables are a collection of records and each record in a table possesses the same fields.

In an alternate embodiment of the present invention, one or more of the databases 204 are implemented using an object database product (e.g., Ode available from Bell Laboratories of Murray Hill, N.J., POET available from the POET Software Corporation of San Mateo, Calif., ObjectStore available from Object Design, Inc. of Burlington, Mass., and the like). As is well known in the relevant art(s), data in object databases are stored as objects and can be interpreted only using the methods specified by each data object's class.

As will be appreciated by one skilled in the relevant art(s), whether the databases 204 are object, relational, or even flat-files would depend on the intended purpose of data storage as driven by the ASP's specific application program(s). The engine 130 contains specific code logic to assemble components from any combination of these database models, to build the required answer to a query. In any event, the user 102 is unaware of how, where, or in what format that such data is stored.

VI Distributing Instructions and Data (Client-Server Switching)

As suggested above, during control flow 300 (i.e., step 322), the dispatcher 202 determines which specific servant machine 206 is available (i.e., which servant machine has the available computation resources in order to service the user 102 session and provide the application program). Then, the dispatcher assigns that specific servant machine 206 to the user 102 by supplying the user 102 with the network address of the servant machine 206 (i.e., data) and instructions (i.e., executable code) indicating how to establish a connection to the servant machine 206.

As also suggested above, during the execution of the application program (i.e., the application management process of step 326 and steps 328-332), the servant machine 206 receives queries from the user, parses them, and determines what resources are required to respond to such queries. The provision of the network to the user 102 and its execution of an application program involves the exchange of data and instructions (i.e., executable code) between the user 102 machine and the servant machine 206 that switches their respective roles as “client” or “server.”

In the above two instances (i.e., step 322 and steps 326-332), instructions and data are pushed to and from one of the servant machines 206 and the user 102 machine. This is achieved by the “pushing” back and forth of instructions (and associated data) derived from computed logic without any knowledge by, or interaction from, the user 102. Answers to queries may be “pushed” between any entities connected to the network, or may be stored for the completion of “push” delivery, when a device which is temporarily unavailable, becomes available again to the network.

As suggested in FIG. 4, part of the application management process of step 326 and steps 328-332 also involves, at a more detailed level, the management of sub-processes that operate as an integral part of the servant machine 206. These processes include the management of communication links that may become disconnected unexpectedly, the unresolved logic of executable program code, hardware failures, and other operations. The detailed step-wise management of these servant sub-processes are managed through by C-Bot 404. The C-bot 404 process manages the ability of each servant process to continue its resolution of a user query, and to provide a means by which errors or faults can be trapped, identified, and submitted to the operating platform for correction. As the S-bot 402 processes are the detailed step-wise process to resolve a specific user 102 query, the C-bot 404 process ensures that no S-Bot 402 process stalls and thereby renders part of the engine 130 non-functional. Similarly, as the C-bot 404 process is constantly aware of the dynamics of the S-Bot 402 processes, the C-Bot 404 process can also provide a means by which temporarily unused S-Bot 402 processes can be assigned to execute brief bursts of code from another thread or processes, to increase the aggregated efficiency of the engine.

In sum, the engine 130 allows application instructions to be passed from one point to another in an optimized format. These instructions are then executed in a location that may be more efficient for the process at hand. The net result is the effective control of the function of each computing component in the network, on a step by step basis. Thus, the contents of the data and application instructions which are present on the network, define, manage and control the processes. Further, engine 130 allows a computational entity (i.e., user 102 machine processes) that conventionally performs the functions solely of a “client,” to be immediately and without human intervention, altered to perform the functions of a “server.” It also allows a computational entity (i.e., servant machine 206 processes) that conventionally performs the functions solely of a “server,” to be immediately and without human intervention, altered to perform the functions of a “client.” In every case, the former “client” that becomes a “server,” has no legacy knowledge of its former role.

As suggested above, the engine 130 code logic is distributed across the various engine 130 components (i.e., dispatcher 202, servant machines 206 and databases 204). The engine 130 code logic also partially resides on the user 102 computer via the instruction and data pushing functionality of the present invention described herein (as illustrated below). That is, the location of the code logic can be moved between locations during a session, by the engine 130. Thus, at any given instance, the code logic that is required to resolve a user 102 query, is assembled by the engine 130 as illustrated below with respect to FIG. 5.

Referring to FIG. 5, a flow diagram of a sample control flow 500, according to an embodiment of the present invention, is shown. More specifically, control flow 500 highlights the instruction and data pushing, as well as the client-server switching functionality of system 200, as mentioned in the above-described instance of steps 326-332. Control flow 500 begins at step 502, with control passing immediately to step 504.

In step 504, the servant machine 206—acting as a “server”—receives a query from the user 102 machine—acting as a “client.” As will be apparent to one skilled in the relevant art(s), the particular query received from the user 102 machine is dependent on the specific application program offered by the ASP and is not germane to the discussion herein.

In step 506, the servant machine 206 would parse the received query and determine what resources (e.g., certain data within database 204) are required to respond. After that determination, the servant machine 206 would create and send instructions as well as data responsive to the received query. In step 508, the user 102 machine would execute the received instructions causing it to become a “server.” Consequently, the servant machine 206 would then become a “client.”

In step 510, the user would execute another query with respect to the application program. In step 512, it is determined whether the user 102 machine has the data that is responsive to the query from step 510. For example, during execution of the application program a user may request information that is stored in database 204. In an effort to increase efficiency, rather than simply returning the exact data requested, which might impair the efficiency of one part of the engine 130, the servant machine 206 may return one or more pages of data along with the instructions in step 506. Consequently, in step 508, the user 102 machine would execute the received instructions causing it to become a “server.”

Thus, in step 510, when the user 102 forms another query, the data responsive to that subsequent query may already reside on the user 102 machine, as determined by step 512-thus making it a server. The instructions sent to the user 102 machine “teaches” it how to behave as a server, or how to perform operations that would not be a part of its native intelligence or instruction repertoire, and use the one or more data pages received to answer its own queries. If the data are not available (i.e., it is not part of the page of data sent in step 506), the servant machine reverts back to its role as a “server” and thus, the user 102 machine revert back to its role as a “client” in step 514. As a consequence of the above, system 200 of the present invention (and more specifically, engine 130) can function as one of a category of applications known as “browsers”, with the important exceptions that it does not require pre-defined formats for the presentation of any page, segment, unit, or quantity of information, and that it requires neither regard as to the information type or category, nor regard to the native ability to execute HTML or other similar page description languages. Therefore, one embodiment of the engine 130 of the present invention functions as a network operating platform for ASP's to offer application programs or other services to their clients.

In step 516, a determination is made as to whether the application program is complete (i.e., the user is done using the application program). If so, control flow 500 then ends as indicated by step 518.

It should be understood that control flow 500, which highlights the secure instruction creation and distribution functionality and other advantages of system 200, is presented for example purposes only. The architecture of the present invention is sufficiently flexible and configurable such that the secure instruction creation and distribution of instructions may flow in ways other than that shown in FIG. 5. In fact, in an embodiment of the present invention, the servant machine 206 may send instructions and data that are only partially responsive to the query. The user 102 machine would then use the instructions (i.e., executable code) and data received from servant machine 206 and then forwards a computed answer to the servant machine 206. The servant machine 206 would then parse the answer received from the user 102 machine and combine it with additional data to form a final response to the query received from the user 102. Thus, a final response would then be formed and sent to the user 102 machine.

During the period when the user 102 machine is action as a “client” it is “stateful” and during the period that the user 102 machine is a “server” it is “stateless.” Being stateless implies that the machine has no legacy information that tells it where in a process it is. Further, there are four states:

the “client” process and “server” process are both stateless;

the “client” process and “server” process are both stateful;

the “client” process is stateless and the “server” process is stateful; or,

the “server” process is stateless and the “client” process is stateful.

The invention described herein can operate in each and any one of these four described states, as is deemed most efficient for its continuing operation, and it may change from one of these four states to any of the other three remaining states for any number of steps or processes.

VII User Machine Kernel

As will be apparent to one skilled in the relevant art(s) after reading the description herein, the user 102 machine would need to contain a kernel that would allow it to execute the instructions received from the servant machines 206 in the two instances described above—the dispatcher assignment of step 322, and the application management process of steps 326-332. As will be appreciated by one skilled in the relevant art(s), a kernel is the part of an operating system—in this case the Internet operating platform of the present invention—that is responsible for resource allocation, low-level hardware interfaces, security, etc. In a preferred embodiment of the present invention, as suggested above, the kernel would be supplied by the ASP to the user 102 and be accessed by means of a connection to an icon on the graphical user interface of the operating system that the user is utilizing in order to initially establish the connection to the network address of the dispatcher 202.

The customer query is first passed in parsed format to the engine 130. This parsing is achieved by a parsing module on the customer machine that is part of the kernel that resides on the user 102 computer. This parsing module translates the customer query into a format directly executable by the engine 130. As a result, only optimized code is transferred between the user 102 and the engine 130. If the parsing commences an iterative action, the engine 130 sends similarly parsed code back to the kernel. The kernel also provides the ability to interpret (and execute) this optimized parsed code on the machine which contains the kernel. In an embodiment of the present invention this bi-directional parsed code is transmitted in the form of symbols. Each ASP may utilize a (proprietary) symbol library for any session which includes both a collection of elementary (i.e., base) symbols and functions related thereto depending on the specific network management, context, and application program being provided by the ASP. Further, a dynamic extension to the base library, which is unique to a particular user 102 session can direct a user 102 machine to execute tasks which are unknown to any other kernel (i.e., user 102) connected to the system 200. This results in a system 200 where each of a multiplicity of diverse and unique users 102 receive the specific resources and capabilities they require to resolve their individual queries, in whatever format they require.

In an embodiment of the present invention, data and code packets are transmitted intermixed, as strings of symbols or ASCII characters. The engine 130 and the kernel know how to parse these strings to separate code from data and one instruction from another. For example, the dispatcher 202 may send the digital information “123.456.789.0:1234” to the kernel on the user machine 102, which would direct the kernel to establish a socket-to socket communications session with a location having a network address of 123.456.789.0, using port number 1234. Strings need not be transmitted in sequence, can be packed so as to minimize the number of packets required for network transmission, and can be encrypted so as to secure their contents.

Further, in an embodiment of the present invention, database 204f (user system data) would be populated by the kernel. The detailed information about the hardware being used by the customer (user 102) comes from data files that are created by the engine code (i.e., the kernel) that is placed on the user 102 machine. These data contain a profile of the hardware and software that the user 102 has installed. More specifically, such data includes the profile data of the customer and the customer's hardware, the member status of the customer, the specific addresses and protocols of the customer's connection to the engine 130, the status of when the user 102 last connected to the engine 130, the version number of the kernel that resides on the user 102 computer, whether the customer is attempting to restart a session that was previously terminated (prematurely) by error, and other information that the ASP may deem important.

In an embodiment of the present invention, this user profile data may be stored as a binary file on the user 102 machine, and is sent to the engine 130 (and stored in database 204f) as the part of the process that identifies the specific user (see control flow 300). Such storage on the user 102 machine can be in RAM, or may be swapped or stored on a more permanent means of digital storage. The sessional parameters data within database 204f are actively updated for some values such as system resources, etc., while other values such as customer hardware may remain static for each session. The file containing the user system data stored on the user 102 machine is also used to identify whether the user 102 machine upon which the kernel is installed, has all the prerequisites to interact with the engine 130 software code logic.

VIII. System Security

The present invention provides a system, method and computer program product for the secure creation and distribution of instructions to support network (e.g., Internet) applications. Thus, various security measures within system 200 are now addressed.

Components 202, 204 and 206 of system 200, as will be apparent to one skilled in the relevant art(s), are connected and communicate via a wide or local area network (WAN or LAN) running a secure communications protocol (e.g., secure sockets layer (SSL)) layered above the connection protocol (e.g., TCP/IP). Further, components 202, 204 and 206 of system 200 may be protected by a firewall (not shown in FIG. 2). Generally speaking, a firewall is a dedicated gateway machine (e.g., a SUN Ultra 10) with special security precaution software. It is typically used, for example, to service network 112 connections and dial-in lines, and protects the cluster of more loosely administered network elements hidden behind it, from external invasion. Firewalls are well known in the relevant art(s) and firewall software is available from many vendors such as Check Point Software Technologies Corp. of Redwood City, Calif.

In an embodiment of the present invention, instructions and data pushed to and from one of the servant machines 206 and the user 102 machine would be encrypted for security purposes. That is, such instructions and data would first be encrypted before transmitting them using the protocol (e.g., TCP/IP) implemented in the network (e.g., the Internet). This would allow the security needs of the application program (e.g., a product ordering application program that involves transmitting user 102 credit card information for payment purposes) to be met. Such encryption could utilize any known cryptography method to prevent any but the intended recipient and author from reading the transmitted instructions and associated data (e.g., RSA public-key encryption, Data Encryption Standard (DES) and the like). Further, a lower bit encryption (e.g., 40-bit or 256-bit encryption) would be used for “normal” (i.e., chat, messaging, or other non-payment) data and a higher bit encryption (e.g., 1024-bit encryption) would be used for any accounting, payment or other financial-type data. A detailed discussion of cryptography can be found in Bruce Schneier, “Applied Cryptography: Protocols, Algorithms, and Source Code in C,” John Wiley & Sons, 2nd ed., ISBN 0-47-112845-7(USA 1996), which is incorporated herein by reference in its entirety.

Further, in one embodiment of the present invention, data for any record stored in the databases 204 may be in both ASCII and encrypted formats. Encryption would be used to store confidential information, where only the author of the data (e.g., user 102 who owns a private key), and the ASP (e.g., a bank who would be given the public key by the user 102) would have the key to decrypt the data, regardless of who had rights to read the data.

In yet still another embodiment of the present invention, instructions and data pushed to and from one of the servant machines 206 and the user 102 machine would be predicated on a digital signature present on the user 102 machine matching a pre-authorized user digital signature (stored in database 204e) checked by the servant machine 206 or the dispatcher 202, as appropriate.

In yet another embodiment, the user profile data stored as a binary file on the user 102 machine, and that is sent to the engine 130 for storage in database 204f, can be in RAM, or may be swapped or stored on a more permanent means of digital storage in an encrypted form.

In an embodiment of the present invention, the security process (steps 316-321 of control flow 300) determines whether the network location of the originator of the “first request for service” is contained in a list of “security failures” contained in the security database 204b. It also checks for validity in the connection method (making sure that the user 102 is attempting to connect to a specific location (network IP address+port address) that is authorized by the system 200), protocols, packet contents, and searches for anomalies in data structure and content (i.e., the library of symbols use for interpretation of parsed code pushed back and forth as explained herein).

As suggested above, If the user 102 fails this security screening process, the user 102 session is either terminated by the dispatcher 202 or is connected to “demo” mode of engine operation and prevented from direct interaction with engine 130 and “real-world” data. If the security screening process is not failed, user 102 is assigned a digital certificate. This certificate is temporary, and resides on the user 102 computer. Then, when the user connects to the servant machine 206 assigned by the dispatcher 202, the user 102 is authenticated using the digital certificate assigned by the dispatcher 202. This prevents entry from known “denial of service” attack origin sites.

In an embodiment of the present invention, each time an authorized user 102 logs on, either the digital certificate or other means may be used to identify such authorized user 102. One such other means includes the use of a special binary file which the security process can be instructed to place on the user 102 computer, to flag it for direct handling of special processes, such as a logging of other Internet site visits, countdown timers, or legal surveillance. The security process also determines the added load that this new connection will impose on the engine 130, by sending a command to the user 102 computer asking it to echo the next string back to the user (which determines the variable LₜᵣUₙEₙ) and then directs the user 102 to execute a proprietary calculation that the servant machine 206 sends to the user 102 computer, and send the result back to the servant machine 206. This determines the variable L_{trc}EₙUₙ to be stored in database 204a for later use by the dispatcher 202.

In an embodiment of the present invention, security database 204b may contain the exemplary fields shown in TABLE 2 in order to provide the engine 130 (and more specifically, dispatcher 202) with the security screening processes described herein.

TABLE 2

| FIELD | DESCRIPTION |
|---|---|
| YlwFlag0 | List of network addresses of prematurely-terminated sessions |
| Addresses | (i.e. dropped connections) |
| YlwFlag1 | network addresses of originators, who have attempted to |
| Addresses | connect to incorrect ports; # of attempts at each port |
| YlwFlag2 | list if network addresses being thoroughly logged for |
| Addresses | suspicious activity |
| YlwFlag3 | list of suspicious character strings, etc. Pre-cursor to virus |
| Strings | detection, hack attempts |
| RedFlag1 | list of network addresses that have attempted “denial of |
| Addresses | service” attacks |
| RedFlag2 | list of network addresses that have attempted unauthorized |
| Address | uploads |
| OrgFlag1 | List of network addresses requiring contact with a customer |
| Addresses | service representative |
| OrgFlag2 | List of network addresses requiring immediate suspension for |
| Addresses | cause |
| GreyFlag1 | List of network addresses with service suspended by request |
| Addresses | of user |
| VltFlag1- | List of network addresses under legal surveillance |
| VltFlagn | |
| Addresses | |

IX. Example Implementations

The present invention (i.e., engine 130, system 200, control flow 300, architecture 400, control flow 500 or any part thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 600 is shown in FIG. 6. The computer system 600 includes one or more processors, such as processor 604. The processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 600 can include a display interface 605 that forwards graphics, text, and other data from the communication infrastructure 602 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an EPROM, Flash ROM, EEPROM, Mask Programmed ROM or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628 which may be electronic, electromagnetic, optical or other signals capable of being received by communications interface 624. These signals 628 are provided to communications interface 624 via a communications path (i.e., channel) 626. This channel 626 carries signals 628 and may be implemented using wire or cable, fiber optics, a phone line, a cellular phone link, an RF link and other communications channels.

In this document, the terms “computer program medium” and “computer usable medium” are used to generally refer to media such as removable storage drive 614, a hard disk installed in hard disk drive 612, and signals 628. These computer program products are means for providing software to computer system 600. The invention is directed to such computer program products.

Application programs (also called computer control logic) are stored in main memory 608 and/or secondary memory 610. Application programs may also be received via communications interface 624. Such application programs, when executed, enable the computer system 600 to perform the features of the present invention as discussed herein. In particular, the computer programs, when executed, enable the processor 604 to perform the features of the present invention.

Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs), or permanent storage means which may be altered, such as Flash ROM. Implementation of the hardware state machine so as to perform the functions described herein will be apparent to persons skilled in the relevant art(s).

In yet another embodiment, the invention is implemented using a combination of both hardware and software.

X Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A method for the secure creation and distribution of instructions to support a network application, comprising the steps of:
(1) receiving a connection request from a user machine;
(2) selecting one of a plurality of servant nodes;
(3) sending a first code package to said user machine, wherein said first code package includes instructions and data that facilitate said user machine connecting to said one of said plurality of servant nodes;
(4) establishing a connection between said user machine and said one of said plurality of servant nodes;
(5) commencing an application on said one of said plurality of servant nodes;
(6) receiving a query from said user, wherein said query is related to said application;
(7) sending a second code package to said user machine, wherein said second code package includes instructions and data partially responsive to said query;
(8) receiving an answer computed by said user machine utilizing said second code package;
(9) parsing said answer received from said user machine and combining said answer with additional data to form a final response to said query received from said user machine; and
(10) sending said user said final response;
whereby said first and second code packages allow an application service provider to support the delivery of a network-based application program that is uniquely presented, structured, and executed for said user.

2. A system for providing an application service provider with a network-based operating platform to deliver application programs to a user, comprising:
(A) a dispatcher connected over a network to at least one user machine, wherein said dispatcher has means for receiving a connection request from said at least one user machine;
(B) a plurality of servant nodes;
(C) a database connected to said dispatcher and to each of said plurality of servant nodes;
(D) means for said dispatcher to access said database in order to select one of said plurality of servant nodes that is available to service said connection request from said at least one user machine;
(E) means, within said a dispatcher, for sending a first code package to said at least one user machine, wherein said first code package includes instructions and data that facilitate its connection to said one of said plurality of servant nodes; and
(F) means for said one of said plurality of servant nodes to access said database in order to send a second code package to said at least one user machine, wherein said second code package includes instructions and data responsive to query received from said at least one user machine;
whereby said second code package allows the application service provider to deliver the network-based application program to the user.

3. The system of claim 2, wherein said network is at least a portion of the Internet.

4. A computer program product comprising a computer usable medium having control logic stored therein for causing a computer to provide the secure creation and distribution of instructions to support a network application, said control logic comprising:
first computer readable program code means for causing the computer to receive a connection request from a user machine;
second computer readable program code means for causing the computer to select one of a plurality of servant nodes;
third computer readable program code means for causing the computer to send a first code package to said user machine, wherein said first code package includes instructions and data that facilitate said user machine connecting to said one of said plurality of servant nodes;
fourth computer readable program code means for causing the computer to establish a connection between said user machine and said one of said plurality of servant nodes;
fifth computer readable program code means for causing the computer to commence an application on said one of said plurality of servant nodes;
sixth computer readable program code means for causing the computer to receiving a query from said user, wherein said query is related to said application;
seventh computer readable program code means for causing the computer to send a second code package to said user machine, wherein said second code package includes instructions and data partially responsive to said query;
eighth computer readable program code means for causing the computer to receive an answer computed by said user machine utilizing said second code package;
ninth computer readable program code means for causing the computer to parse said answer received from said user machine and combining said answer with additional data to form a final response to said query received from said user machine; and
tenth computer readable program code means for causing the computer to sending said user said final response.
